(19) United States
(12) Patent Application Publication
(10) Pub. No.: US 2019/0387688 A1
(43) Pub. Date: Dec. 26, 2019

(54) PLANT HOLDER

(71) Applicant: The Board of Trustees of The University of Alabama, Tuscaloosa, AL (US)

(72) Inventor: James Edward White, Tuscaloosa, AL (US)

(21) Appl. No.: 16/451,176

(22) Filed: Jun. 25, 2019

Related U.S. Application Data
(60) Provisional application No. 62/689,420, filed on Jun. 25, 2018.

(51) Int. Cl. A01G 9/02

(52) U.S. Cl. CPC A01G 9/02

(57) ABSTRACT

Various implementations include a plant holder that includes at least one wall having an inner surface, a first end, and a second end. The inner surface of the at least one wall defines a channel, along with a first opening to the channel and a second opening to the channel. The first end and the second end of the at least one wall are spaced apart along a central axis that extends through the openings. The plant holder also includes at least two legs extending axially from and being spaced around a perimeter of the second end of the at least one wall. Adjacent edges of adjacent legs define a gap therebetween.

### BACKGROUND

When plants are placed in a traditional vase, the ends of the stems of the plants must be trimmed and the water must be changed periodically to maintain the plants' health over time. Traditional vases for holding plants do not allow easy access to stems and require the originally designed plant bouquet to be removed and disturbed to change the water and cut the stems. In applications in which large numbers of plant arrangements are maintained (e.g., within the hospitality and floral industries), trimming stems and changing water in traditional vases can be time consuming. Thus, a need exists for a device that allows plant bouquets to be easily removed from a vase without disturbing the arrangement and allows for easy access to the plant stems for trimming.

### BRIEF SUMMARY

Various implementations include a plant holder. The plant holder includes at least one wall and at least two legs. The wall has an inner surface, a first end, and a second end. The inner surface of the wall defines a channel. The inner surface of the wall defines a first opening to the channel and a second opening to the channel. The first end and the second end are spaced apart along a central axis that extends through the openings. The two legs extend axially from and are spaced around a perimeter of the one wall. Adjacent edges of adjacent legs define a gap therebetween.

In some implementations, the at least two legs include three legs.

In some implementations, the at least one wall is cylindrical and defines a closed perimeter.

In some implementations, the at least two legs have an arcuate shaped cross section as viewed from a plane that bisects the cylindrical wall through the central axis. The radius of curvature of each arcuate shaped cross section is the same as a radius of curvature of the cylindrical wall.

In some implementations, the at least one wall includes three or more walls that define a prism.

In some implementations, the at least two legs are cylindrical shaped.

In some implementations, the at least two legs are prism shaped.

In some implementations, each leg has a proximal end coupled to the at least one wall. The distal end is opposite the proximal end. The distance between the second end of the wall and the distal end of each leg is adjustable.

In some implementations, each leg includes a plurality of sections that telescope relative to each other.

In some implementations, the at least one wall has an outer surface that is spaced apart from the inner surface. The second end of the at least one wall defines a plurality of holes that extend through at least a portion of the wall between the inner surface and the outer surface. Each leg is slidably disposed within a respective one of the plurality of holes.

In some implementations, the at least one wall has an outer surface spaced apart from the inner surface. The second end of the at least one wall defines a plurality of threaded holes that extend through at least a portion of the wall between the inner surface and the outer surface. The proximal end of each leg is threaded and is threadingly engaged in a respective threaded hole.

In some implementations, the at least one wall and/or the at least two legs include a transparent, translucent, and/or opaque material.

In some implementations, the at least one wall has an outer surface and at least two protrusions extend from the outer surface of the at least one wall.

In some implementations, the at least one wall has at least two protrusions extending from the first end of the at least one wall.

In some implementations, the at least one wall has an outer surface and the outer surface of the at least one wall defines at least two cavities.

In some implementations, the at least one wall has an outer surface and the outer surface of the at least one wall defines at least two apertures extending from the outer surface to the inner surface.

In various other implementations, a plant holding system includes a vase defining an inner cavity and a plant holder. The inner cavity includes a bottom surface. The plant holder includes at least one wall and at least two legs. The at least one wall has an inner surface, a first end, and a second end. The inner surface of the at least one wall defines a channel. The inner surface of the at least one wall also defines a first opening to the channel and a second opening to the channel. The first end and the second end are spaced apart along a central axis that extends through the openings. The at least two legs extend axially from and are spaced around a perimeter of the second end of the at least one wall. Adjacent edges of adjacent legs define a gap therebetween. The plant holder is disposed within the inner cavity of the vase. Distal ends of the legs are disposed adjacent the bottom surface.

In some implementations, the at least two legs include three legs.

In some implementations, the at least one wall is cylindrical and defines a closed perimeter.

In some implementations, the at least two legs have an arcuate shaped cross section as viewed from a plane that bisects the cylindrical wall through the central axis. The radius of curvature of each arcuate shaped cross section is the same as a radius of curvature of the cylindrical wall.

In some implementations, the at least one wall includes three or more walls that define a prism.

In some implementations, the at least two legs are cylindrical shaped.

In some implementations, the at least two legs are prism shaped.

In some implementations, each leg has a proximal end coupled to the at least one wall. The distal end is opposite the proximal end. The distance between the second end of the wall and the distal end of each leg is adjustable.

In some implementations, each leg includes a plurality of sections that telescope relative to each other.

In some implementations, the at least one wall has an outer surface that is spaced apart from the inner surface. The second end of the at least one wall defines a plurality of holes that extend through at least a portion of the wall between the inner surface and the outer surface. Each leg is slidably disposed within a respective one of the plurality of holes.

In some implementations, the at least one wall has an outer surface spaced apart from the inner surface. The second end of the at least one wall defines a plurality of threaded holes that extend through at least a portion of the wall between the inner surface and the outer surface. The proximal end of each leg is threaded and is threadingly engaged in a respective threaded hole.

In some implementations, the at least one wall and/or the at least two legs include a transparent, translucent, and/or opaque material.

In some implementations, the at least one wall has an outer surface and at least two protrusions extend from the outer surface of the at least one wall.

In some implementations, the at least one wall has at least two protrusions extend from the first end of the at least one wall.

In some implementations, the at least one wall has an outer surface and the outer surface of the at least one wall defines at least two cavities.

In some implementations, the at least one wall has an outer surface. The outer surface of the at least one wall defines at least two apertures extending from the outer surface to the inner surface.

### BRIEF DESCRIPTION OF DRAWINGS

Example features and implementations are disclosed in the accompanying drawings. However, the present disclosure is not limited to the precise arrangements and instrumentalities shown.

FIG. 1 is a perspective view of plant holder in accordance with one implementation.

FIG. 2 is a perspective view of the plant holder of FIG. 1 disposed within the inner cavity of a vase.

FIG. 3 is a perspective view of a plant holder in accordance with another implementation.

FIG. 4 is a perspective view of a plant holder in accordance with another implementation.

FIGS. 5A-D are perspective views of the plant holders in accordance with other implementations.

FIGS. 6A-C are perspective views of the legs of plant holders in accordance with other implementations.

### DETAILED DESCRIPTION

Various implementations include a plant holder that includes at least one wall having an inner surface, a first end, and a second end. The inner surface of the at least one wall defines a channel. The first end defines a first opening to the channel, and the second end defines a second opening to the channel. The first end and the second end of the at least one wall are spaced apart along a central axis that extends through the openings. The plant holder also includes at least two legs that extend axially from and are spaced around a perimeter of the second end of the at least one wall. Adjacent edges of adjacent legs define a gap therebetween.

According to various other implementations, a plant holding system includes a vase defining an inner cavity with a bottom surface. The plant holding system also includes a plant holder, such as the plant holder described above. The plant holder is disposed within the inner cavity of the vase, and distal ends of the legs are disposed adjacent the bottom surface.

In use, the stems of one or more plants are inserted from the first opening of the at least one wall of the plant holder, through the channel, and out of the second opening such that the ends of the stems are disposed between the legs of the plant holder. The plant holder and one or more plants can then be inserted into a vase such that the distal ends of the legs of the plant holder are disposed adjacent the bottom surface of the vase.

The plant holder holds the stems of the plants such that the entire bouquet of flowers can be removed from the vase without disturbing the arrangement. Furthermore, access to the stems is available through the gap between adjacent edges of adjacent legs so that the ends of the stems can be trimmed while the plant holder is removed from the vase.

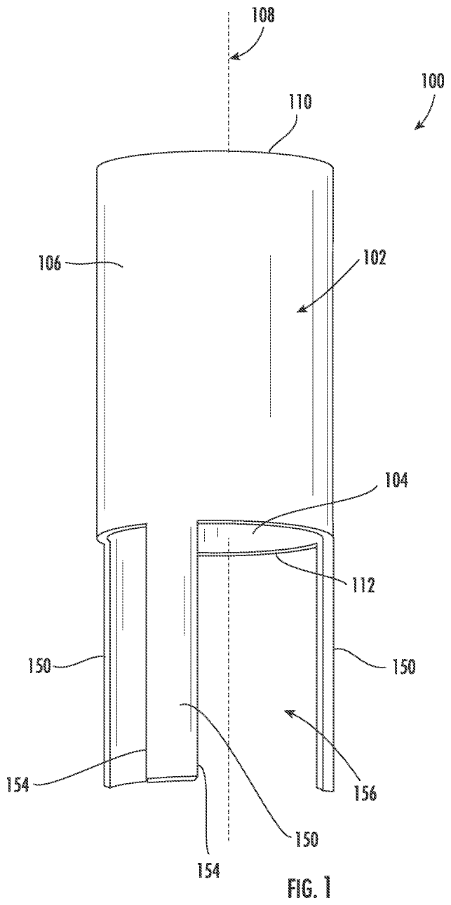

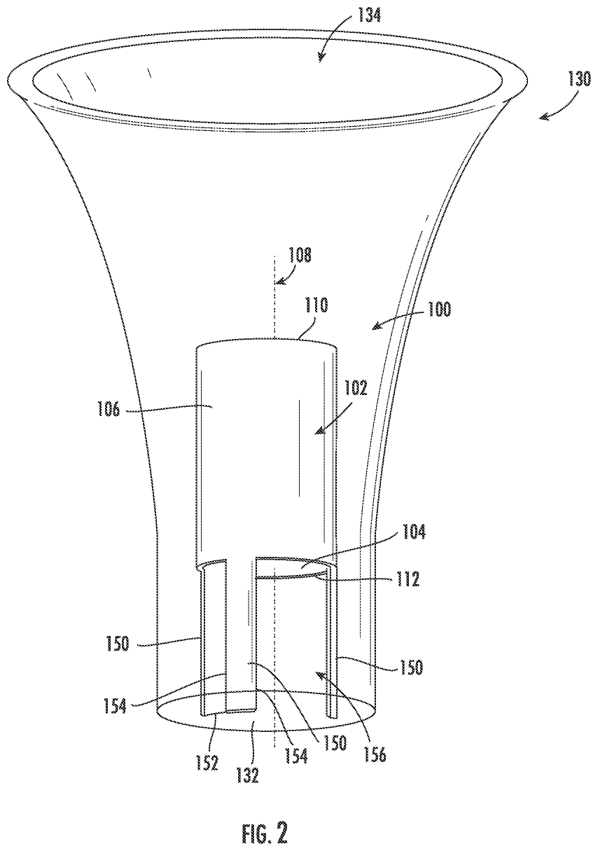

FIG. 1 shows one implementation of a plant holder 100 including a wall 102 and legs 150. The wall 102 is cylindrically shaped and has a central axis 108, an inner surface 104 that faces the axis 108, an outer surface 106 that is opposite and spaced apart from the inner surface 104, a first end 110, and a second end 112. The first 110 and second ends 112 are annular shaped, each defining a central opening therethrough. The inner surface 104 of the wall 102 and the openings defined by each end 110, 112 define a channel that extends along the axis 108. The plant holder 100 has three legs 150 extending axially from the second end 112 of the wall 102. The three legs 150 are spaced around the perimeter of the second end 112 of the wall 102 such that adjacent edges 154 of adjacent legs 150 define a gap 156 between them. The legs 150 have an arcuate shaped cross section as viewed from a plane that bisects the wall 102 through the central axis 108. The radius of curvature of each arcuate shaped leg 150 has the same radius of curvature as the cylindrical wall 102. Although the plant holder 100 shown in FIG. 1 has three legs, in other implementations, the plant holder can have two or more legs.

The wall and/or legs of the plant holder can be made of a transparent, translucent, and/or opaque material so that the plant holder is less visible when disposed within a vase.

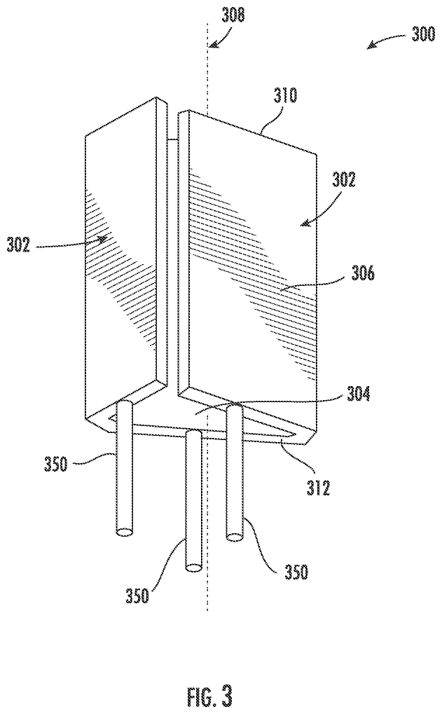

FIG. 2. shows the plant holder 100 of FIG. 1 disposed within the inner cavity 134 defined by a vase 130. Each of the legs 150 of the plant holder 100 has a distal end 152 that is axially spaced apart from the second end 112 of the wall 102, and the distal ends 152 of the legs 150 are disposed adjacent the bottom surface 132 of the inner cavity 134 of the vase 130.

Although the wall 102 of FIGS. 1 and 2 is a closed cylindrical shape, in other implementations, the wall can be another prismatic shape having a channel defined along an axis thereof, and the shape does not need to be a closed shape. For example, FIG. 3 shows another implementation of a plant holder 300 that has three walls 302 that form an open triangular prism around the central axis 308 and cylindrically shaped legs 350. In another implementation, the perimeter of the wall may define an axial oriented gap between adjacent edges of the wall. The wall may be made of a compressible material such that the diameter of the wall may be adjusted by squeezing the wall radially inwardly.

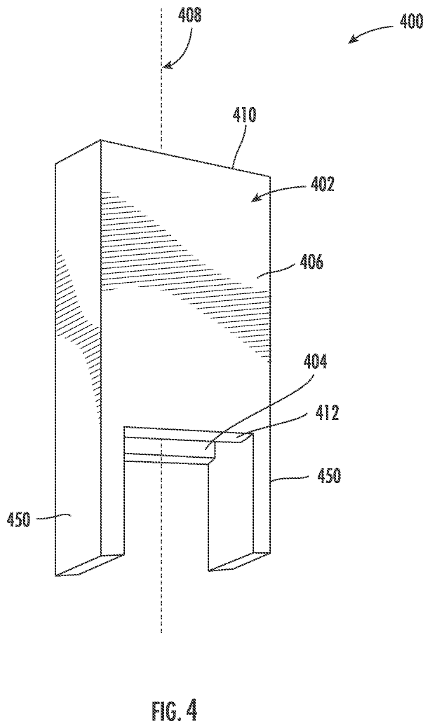

FIG. 4 shows another implementation of a plant holder 400 with legs 450 that are differently shaped and with different numbers of legs 450. FIG. 4 shows a plant holder 400 with two legs 450 that are rectangular prisms. Although FIGS. 1-4 show various implementations of plant holders 100, 300, 400 with differently shaped legs 150, 350, 450 and with different numbers of legs 150, 350, 450, various other implementations can have more legs and the legs can be any shape so long as a gap remains between adjacent edges of adjacent legs such that access to the plant stem ends is possible between adjacent legs.

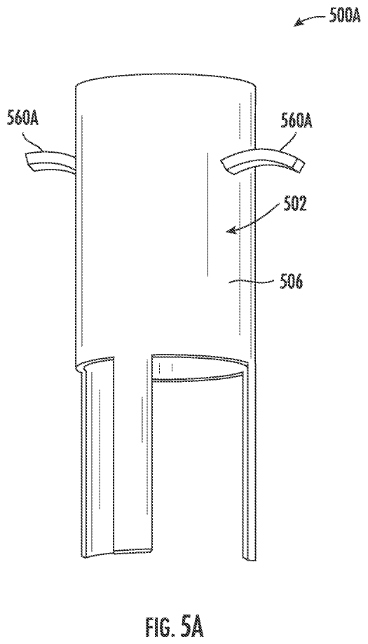

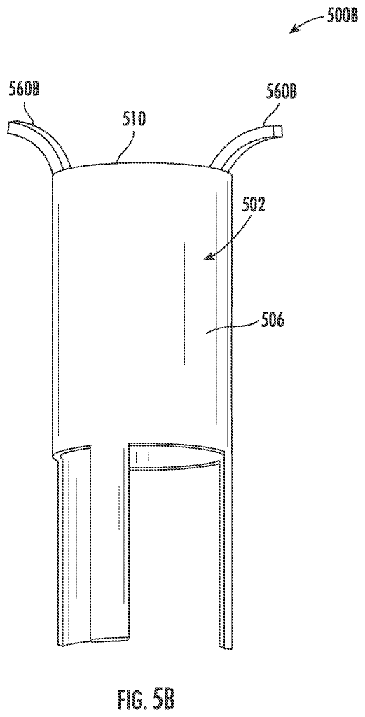

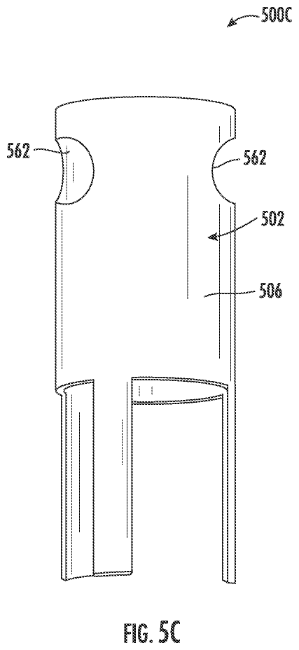

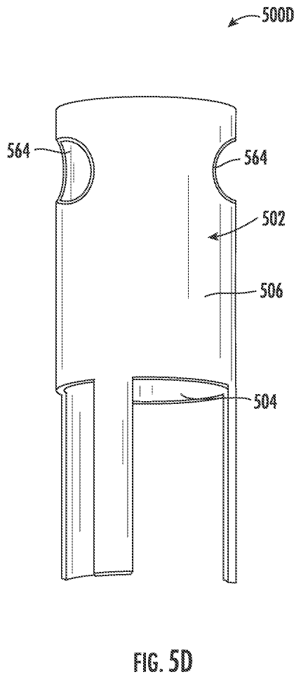

FIGS. 5A-D show implementations of plant holders 500A-D similar to the plant holders in FIGS. 1-4, but with features to aid in lifting the plant holder 500A-D. These lifting features may be included with any of the implementations of the plant holders described herein. FIG. 5A shows a plant holder 500A with two protrusions 560A extending radially from the outer surface 506 of the wall 502. FIG. 5B shows a plant holder 500B with two protrusions 560B extending radially from the first end 510 of the wall 502. Although the protrusions 560A, 560B in FIGS. 5A and 5B are arcuate in shape, in other implementations, the protrusions can be any other shape (e.g., nobs, loops, straight). FIG. 5C shows a plant holder 500C with a wall 502 that defines two cavities 562 extending radially inwardly from the outer surface 506 of the wall 502. FIG. 5D shows a plant holder 500D with a wall 502 that defines two apertures 564 extending radially through the outer surface 506 of the wall 502 and the inner surface 504 of the wall 502. Although each of the plant holders 500A-D in the FIGS. 5A-D have two features to aid in lifting the plant holder, in other implementations, the plant holder can have any number of features to aid in lifting the plant holder.

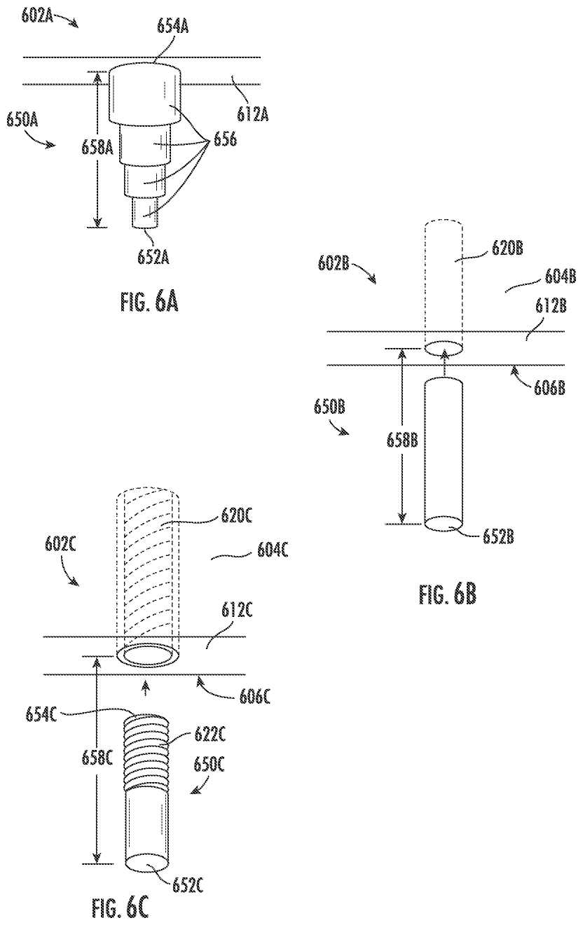

In the above described implementations, the legs are a fixed length. However, in other implementations, the legs are adjustable to vary the length of the legs as measured from the second end of the wall to a distal end of the leg. Adjustable legs may be included with any of the implementations of plant holders described above. FIG. 6A shows one implementation of a leg 650A of a plant holder 600A that is similar to the plant holders shown in FIGS. 1-5, but the leg 650A of FIG. 6A includes a plurality of telescoping sections 656. The plurality of sections 656 each have consecutively smaller diameters such that an inner surface of a first section 656 and an outer surface of a second section 656 that is adjacent to the first section and disposed axially distally of the first section form an interference fit. In other words, the sections 656 are concentrically arranged. In this way, the total length 658A of the leg 650A, as measured from a proximal end 654A of the leg 650A coupled to the second end 612A of the wall 602A to a distal end 652A axially spaced apart from the second end 612A of the wall 602A can be adjusted.

FIG. 6B shows another implementation of an adjustable length leg 650B. The second end 612B of the wall 602B defines a bore 620B extending through a portion of the second end 612B of the wall 602B between the inner surface 604B and outer surface 606B. The leg 650B is cylindrically shaped and is urged within the bore 620B a certain distance into the bore 620B based on a desired leg length 658B of the leg 650B as measured from the second end 612B of the wall 602B to a distal end 652B distal to the second end 612B of the wall 602B. An outer surface of the leg 650B and the inner surface of the bore 620B form an interference fit.

FIG. 6C show another implementation of an adjustable length leg 650C. The second end 612C of the wall 602C defines a threaded bore 620C extending through a portion of the wall 602C between the inner surface 604C and outer surface 606C. A portion 622C of the leg 650C has helical threads that extend radially outwardly from at least a portion of the outer surface of the leg 650C. The threaded portion 622C of the leg 650C can be screwed into the threaded cylindrical bore 620C to adjust the length 658C of the leg 650C as measured from the second end 612C of the wall 602C to a distal end 652C distal to the second end 612C of the wall 602C.

A number of implementations have been described herein. Nevertheless, it will be understood that various modifications may be made without departing from the spirit and scope of the claims. Accordingly, other implementations are within the scope of the following claims.

Certain terminology is used herein for convenience only and is not to be taken as a limitation on the present invention. In the drawings, the same reference numbers are employed for designating the same elements throughout the several figures. A number of examples are provided, nevertheless, it will be understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

1. A plant holder comprising:
at least one wall having an inner surface, a first end, and a second end, the inner surface of the at least one wall defining a channel, the inner surface of the at least one wall also defining a first opening to the channel and a second opening to the channel, the first end and the second end being spaced apart along a central axis that extends through the openings; and
at least two legs extending axially from and being spaced around a perimeter of the second end of the at least one wall, wherein adjacent edges of adjacent legs define a gap therebetween.

2. The plant holder of claim 1, wherein the at least two legs comprise three legs.

3.-7. (canceled)

8. The plant holder of claim 1, wherein each leg has a proximal end coupled to the at least one wall, a distal end that is opposite the proximal end, and a distance between the second end of the wall and the distal end of each leg is adjustable.

9. The plant holder of claim 8, wherein each leg comprises a plurality of sections that telescope relative to each other.

10. The plant holder of claim 8, wherein the at least one wall has an outer surface that is spaced apart from the inner surface, and the second end of the at least one wall defines a plurality of holes that extend through at least a portion of the wall between the inner surface and the outer surface, and each leg is slidably disposed within a respective one of the plurality of holes.

11. The plant holder of claim 8, wherein the at least one wall has an outer surface spaced apart from the inner surface, and the second end of the at least one wall defines a plurality of threaded holes that extend through at least a portion of the wall between the inner surface and the outer surface, wherein the proximal end of each leg is threaded and is threadingly engaged in a respective threaded hole.

12. The plant holder of claim 1, wherein the at least one wall and/or the at least two legs comprise a transparent, translucent, and/or opaque material.

13. The plant holder of claim 1, wherein the at least one wall has an outer surface and at least two protrusions extend from the at least one wall.

14. (canceled)

15. The plant holder of claim 1, wherein the at least one wall has an outer surface and the outer surface of the at least one wall defines at least two cavities.

16. The plant holder of claim 1, wherein the at least one wall has an outer surface and the outer surface of the at least one wall defines at least two apertures extending from the outer surface to the inner surface.

17. A plant holding system comprising:
a vase defining an inner cavity with a bottom surface; and
a plant holder comprising:
at least one wall having an inner surface, a first end, and a second end, the inner surface of the at least one wall defining a channel, the inner surface of the at least one wall also defining a first opening to the channel and a second opening to the channel, the first end and the second end being spaced apart along a central axis that extends through the openings; and
at least two legs extending axially from and being spaced around a perimeter of the second end of the at least one wall, wherein adjacent edges of adjacent legs define a gap therebetween,
wherein the plant holder is disposed within the inner cavity of the vase, and distal ends of the legs are disposed adjacent the bottom surface.

18. The plant holder of claim 17, wherein the at least two legs comprise three legs.

19.-23. (canceled)

24. The plant holder of claim 17, wherein each leg has a proximal end coupled to the at least one wall, a distal end that is opposite the proximal end, and a distance between the second end of the wall and the distal end of each leg is adjustable.

25. The plant holder of claim 24, wherein each leg comprises a plurality of sections that telescope relative to each other.

26. The plant holder of claim 24, wherein the at least one wall has an outer surface that is spaced apart from the inner surface, and the second end of the at least one wall defines a plurality of holes that extend through at least a portion of the wall between the inner surface and the outer surface, and each leg is slidably disposed within a respective one of the plurality of holes.

27. The plant holder of claim 24, wherein the at least one wall has an outer surface spaced apart from the inner surface, and the second end of the at least one wall defines a plurality of threaded holes that extend through at least a portion of the wall between the inner surface and the outer surface, wherein the proximal end of each leg is threaded and is threadingly engaged in a respective threaded hole.

28. The plant holder of claim 17, wherein the at least one wall and/or the at least two legs comprise a transparent, translucent, and/or opaque material.

29. The plant holder of claim 17, wherein the at least one wall has an outer surface and at least two protrusions extend from the at least one wall.

30. (canceled)

31. The plant holder of claim 17, wherein the at least one wall has an outer surface and the outer surface of the at least one wall defines at least two cavities.

32. The plant holder of claim 17, wherein the at least one wall has an outer surface and the outer surface of the at least one wall defines at least two apertures extending from the outer surface to the inner surface.
